(19) United States
(12) Patent Application Publication
(10) Pub. No.: US 2026/0268357 A1
(43) Pub. Date: Sep. 10, 2026

(54) PREDICTION DEVICE, PREDICTION METHOD, AND RECORDING MEDIUM

(71) Applicant: NEC Corporation, Tokyo (JP)

(72) Inventor: Yuichi YANO, Tokyo (JP)

(73) Assignee: NEC Corporation, Tokyo (JP)

(21) Appl. No.: 19/166,635

(22) PCT Filed: Mar. 30, 2023
(86) PCT No.: PCT/JP2023/013163

§ 371 Date: Sep. 18, 2025

(51) Int. Cl. G06Q 30/0202; G06Q 30/0201

(52) U.S. Cl. CPC G06Q 30/02022; G06Q 30/02017

(57) ABSTRACT

In a prediction device, a graph data generation means generates graph data including a plurality of nodes and links indicating relationships between the nodes based on product information, customer information, and a purchase history. A new product generation means extracts product features from the graph data, and generates a new product based on a new combination of the product features. A new product addition means adds the new product to the graph data. A model generation means generates a prediction model that predicts a purchase probability from a combination of a product and a customer by using the graph data to which the new product is added. A customer feature generation means extracts customer features from the graph data to which the new product is added, and generates a combination of the customer features. An acquisition means acquires the new product and the combination of the customer features. A prediction means predicts a purchase probability that a customer having the combination of the customer features will purchase the new product by using the prediction model. The prediction device can support decision-making regarding planning of the new product.

### TECHNICAL FIELD

The present disclosure relates to a prediction technology using graph data.

### BACKGROUND ART

In recent years, a system that supports new product planning and development work has been known, but concept creation in the new product planning and the like often depends on experience and knowledge of a person in charge. Therefore, it is desirable to be able to perform the new product planning based on past data and the like without depending on the experience and the knowledge of the person in charge. For example, Patent Document 1 proposes a design support device capable of evaluating, for design of a product, impressions of the product based on a set of design elements related to portions of the product, and supporting improvement of the impressions.

### PRECEDING TECHNICAL REFERENCE

### Patent Document

Patent Document 1: WO 2021/009880 A1

### SUMMARY

### Problem to be Solved

In the method of Patent Document 1, an evaluation value for each product feature for each target segment is required as teacher data, but in order to obtain a highly reliable evaluation value, a large number of monitor investigations are required, and labor and time are required.

An example object of the present disclosure is to provide a prediction device capable of predicting a new product having a high purchase probability using an existing purchase history or the like.

### Means for Solving the Problem

According to an example aspect of the present invention, there is provided a prediction device, including:
graph data generation means for generating graph data including a plurality of nodes and links indicating relationships between the nodes based on product information, customer information, and a purchase history;
new product generation means for extracting product features from the graph data and generating a new product based on a new combination of the product features;
new product addition means for adding the new product to the graph data; model generation means for generating a prediction model that predicts a purchase probability from a combination of a product and a customer by using the graph data to which the new product is added;
customer feature generation means for extracting customer features from the graph data to which the new product is added and generating a combination of the customer features;
acquisition means for acquiring the new product and the combination of the customer features; and
prediction means for predicting a purchase probability that a customer having the combination of the customer features will purchase the new product by using the prediction model.

According to another example aspect of the present invention, there is provided a prediction method including:
generating graph data including a plurality of nodes and links indicating relationships between the nodes based on product information, customer information, and a purchase history;
extracting product features from the graph data and generating a new product based on a new combination of the product features;
adding the new product to the graph data;
generating a prediction model that predicts a purchase probability from a combination of a product and a customer by using the graph data to which the new product is added;
extracting customer features from the graph data to which the new product is added and generating a combination of the customer features;
acquiring the new product and the combination of the customer features; and predicting a purchase probability that a customer having the combination of the customer features will purchase the new product by using the prediction model.

According to a further example aspect of the present invention, there is provided a recording medium recording a program for causing a computer to execute processing including:
generating graph data including a plurality of nodes and links indicating relationships between the nodes based on product information, customer information, and a purchase history;
extracting product features from the graph data and generating a new product based on a new combination of the product features;
adding the new product to the graph data; generating a prediction model that predicts a purchase probability from a combination of a product and a customer by using the graph data to which the new product is added;
extracting customer features from the graph data to which the new product is added and generating a combination of the customer features; acquiring the new product and the combination of the customer features; and predicting a purchase probability that a customer having the combination of the customer features will purchase the new product by using the prediction model.

### Effect

According to the present disclosure, it is possible to predict a new product having a high purchase probability using an existing purchase history or the like.

### BRIEF DESCRIPTION OF THE DRAWINGS

FIG. 1 illustrates an overall configuration of a prediction device according to a first example embodiment.

FIG. 2 is a block diagram illustrating a hardware configuration of the prediction device of the first example embodiment.

FIG. 3 is a diagram illustrating a functional configuration of the prediction device of the first example embodiment.

FIGS. 4A, 4B and 4C illustrate examples of data structures of customer information, product information, and a purchase history.

FIG. 5 schematically illustrates graph data.

FIG. 6 schematically illustrates the graph data to which a new product is added.

FIG. 7 schematically illustrates the learned graph data.

FIG. 8 is a flowchart of processing by a training unit of the prediction device of the first example embodiment.

FIGS. 9A and 9B illustrate an example of an output result by the prediction device of the first example embodiment.

FIG. 10 is a flowchart of processing by a prediction unit of the prediction device of the first example embodiment.

FIG. 11 is a flowchart of the processing by the prediction unit of the prediction device of the first example embodiment.

FIG. 12 is a diagram illustrating a functional configuration of a prediction device according to a second example embodiment.

FIG. 13 is a flowchart of processing by the prediction device of the second example embodiment.

### EXAMPLE EMBODIMENTS

Hereinafter, preferred example embodiments of the present disclosure will be described with reference to the drawings.

### First Example Embodiment

### [System Configuration]

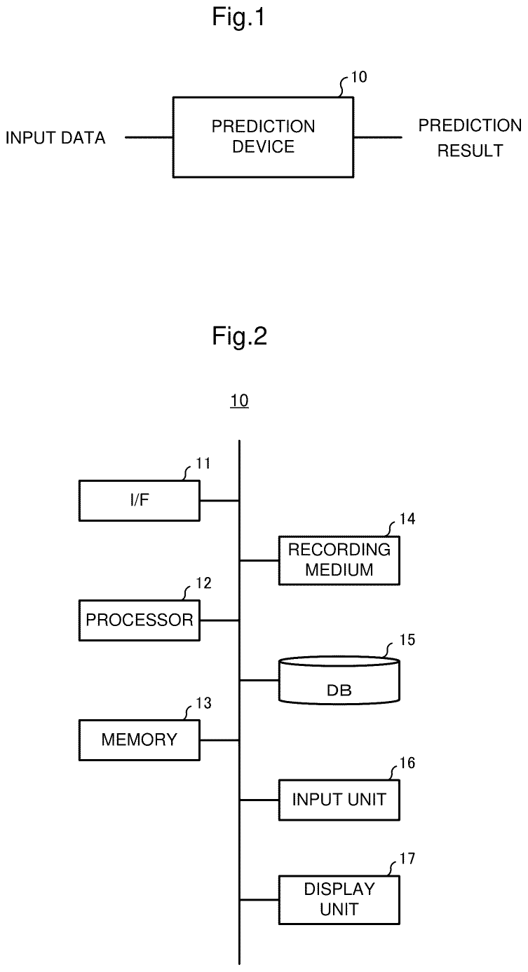

FIG. 1 illustrates a prediction device according to the present example embodiment. A prediction device 10 trains a prediction model based on input data such as product information, customer information, and a purchase history. The prediction device 10 then predicts, using the prediction model, a probability that a customer will purchase a new product.

### [Hardware Configuration]

FIG. 2 is a block diagram illustrating a hardware configuration of the prediction device 10. As illustrated, the prediction device 10 includes an interface (IF) 11, a processor 12, a memory 13, a recording medium 14, a database (DB) 15, an input unit 16, and a display unit 17.

The IF 11 inputs and outputs data to and from an external device. Specifically, the prediction device 10 acquires product information, customer information, and a purchase history through the IF 11. A prediction result by the prediction device 10 is output to the external device through the IF 11 as needed.

The processor 12 is a computer such as a central processing unit (CPU), and takes overall control of the prediction device 10 by executing a program prepared in advance. As the processor 12, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like can be used. Specifically, the processor 12 executes prediction model generation processing and prediction processing to be described later.

The memory 13 includes a read only memory (ROM), a random access memory (RAM), and the like. The memory 13 is also used as a work memory during execution of various types of processing by the processor 12.

The recording medium 14 is a non-volatile non-transitory recording medium such as a disk-shaped recording medium, a semiconductor memory, or the like, and is attachable to and detachable from the prediction device 10. The recording medium 14 records various programs executed by the processor 12. In a case where the prediction device 10 executes various types of processing, a program recorded in the recording medium 14 is loaded into the memory 13, and is executed by the processor 12.

The DB 15 stores product information, customer information, a purchase history, and the like input through the IF 11. The DB 15 also stores graph data generated by the prediction device 10 and the like as a graph database.

The input unit 16 is, for example, a keyboard, a mouse, or the like, and is used by a user to input input data on which prediction is based.

The display unit 17 is, for example, a liquid crystal display device or the like, and displays a prediction result by the prediction device 10.

### [Functional Configuration]

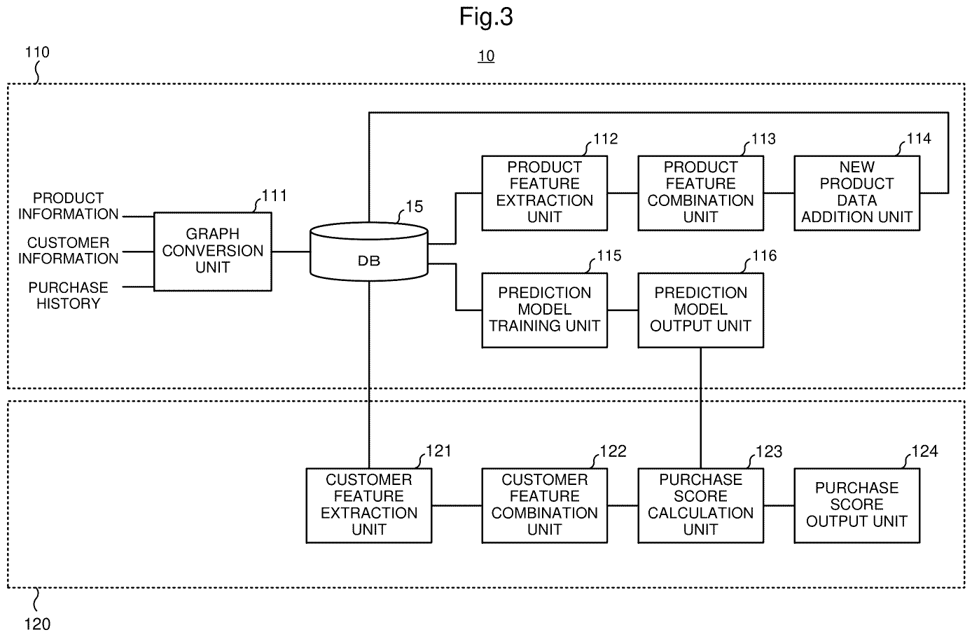

FIG. 3 is a block diagram illustrating a functional configuration of the prediction device 10. The prediction device 10 functionally includes a training unit 110 and a prediction unit 120 in addition to the DB 15 described above.

### (Training Unit)

First, the training unit 110 will be described. The training unit 110 includes a graph conversion unit 111, a product feature extraction unit 112, a product feature combination unit 113, a new product data addition unit 114, a prediction model training unit 115, and a prediction model output unit 116.

The prediction device 10 receives input of product information, customer information, and a purchase history through the IF 11. The graph conversion unit 111 generates graph data based on the product information, the customer information, and the purchase history, and outputs the graph data to the DB 15.

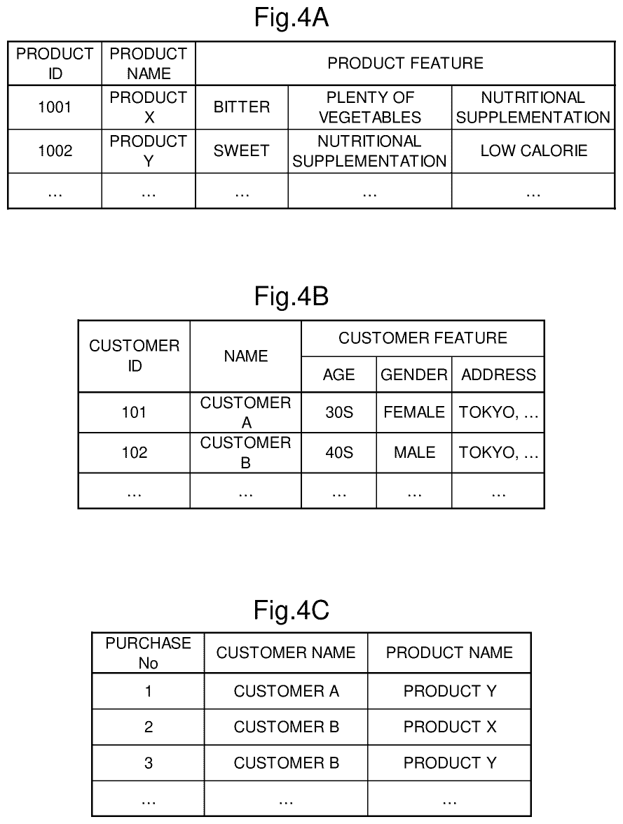

FIG. 4 illustrates examples of the product information, the customer information, and the purchase history. FIG. 4A illustrates an example of the product information. The product information includes a product ID that uniquely identifies a product, a product name, a product feature, and the like. The product feature indicates a feature of the product such as, for example, sweet, bitter, high calorie, low calorie, and nutritional supplementation. FIG. 4B illustrates an example of the customer information. The customer information includes a customer ID that uniquely identifies a customer, a name of the customer, a customer feature, and the like. The customer feature indicates attributes of the customer, for example, an age of the customer, a gender of the customer, an address of the customer, and the like. FIG. 4C illustrates an example of the purchase history. The purchase history includes a purchase No that uniquely identifies a transaction, a customer name, and a product name. The product information, the customer information, and the purchase history illustrated in FIG. 4 are examples, and are not limited to these.

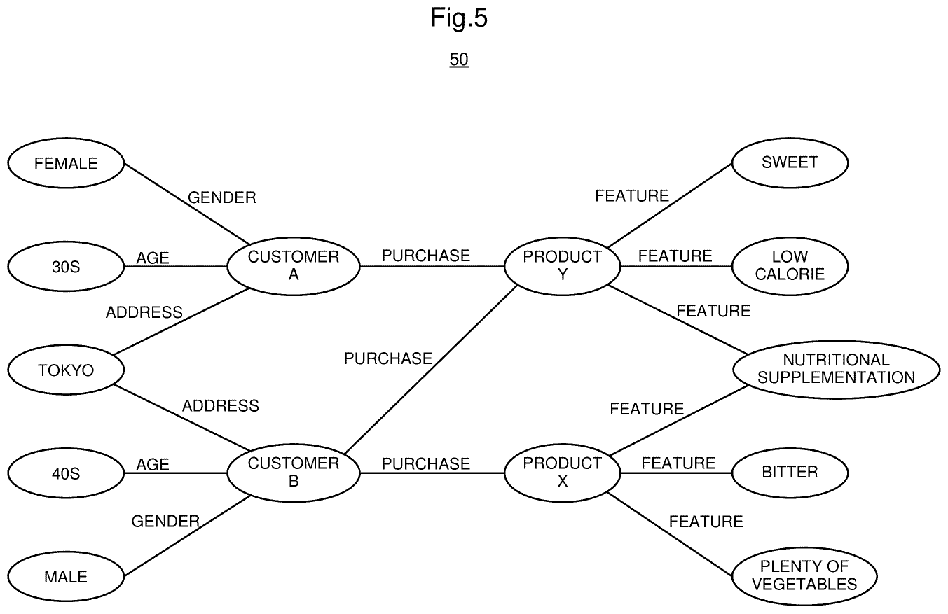

FIG. 5 schematically illustrates graph data generated by the graph conversion unit 111. Graph data 50 in FIG. 5 indicates the product information, the customer information, and the purchase history in a knowledge graph. The graph data includes nodes, links, and relations. The nodes correspond to the product name, the product feature, the customer name, or the customer feature. The links indicate connection between nodes. The relations indicate a relationship between nodes. For example, in the graph data 50, a link is added between a node “customer A” and a node “female”, and a relationship between them is indicated as a “gender”. In the graph data 50, a link is added between a node “product Y” and a node “sweet”, and a relationship between them is indicated as a “feature”. In the graph data 50, a link is added between the node “customer A” and the node “product Y”, and a relationship between them is indicated as “purchase”.

Returning to FIG. 3, the product feature extraction unit 112 acquires the graph data from the DB 15. The product feature extraction unit 112 then extracts product features from the graph data, and generates a product feature list. The product feature extraction unit 112 outputs the product feature list to the product feature combination unit 113.

The product feature combination unit 113 generates a new product based on the product feature list input from the product feature extraction unit 112. Specifically, the product feature combination unit 113 selects one or a plurality of product features from the product feature list, and generates one or a plurality of new combinations of the product features. Hereinafter, a product having the new combination of the product features is also referred to as a “new product”. The product feature combination unit 113 outputs the new product to the new product data addition unit 114.

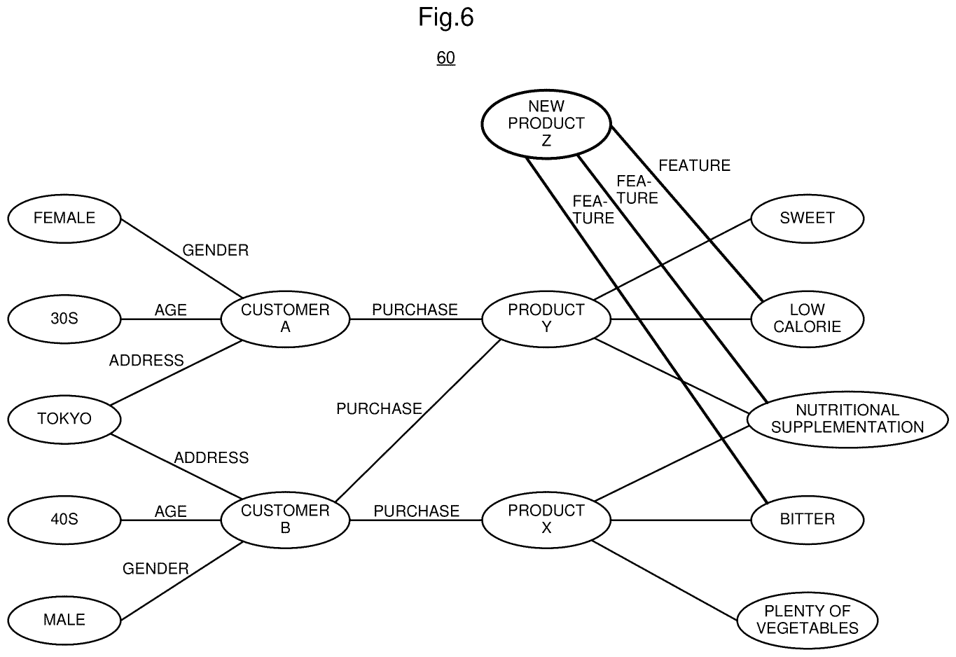

The new product data addition unit 114 adds the new product input from the product feature combination unit 113 to the graph data of the DB 15. FIG. 6 schematically illustrates the graph data to which the new product is added. Graph data 60 of FIG. 6 is obtained by adding a new product Z to the graph data 50 of FIG. 5. The new product Z has product features such as “low calorie”, “nutritional supplementation”, and “bitter”, and links are provided between the new product Z and the product features of the new product Z.

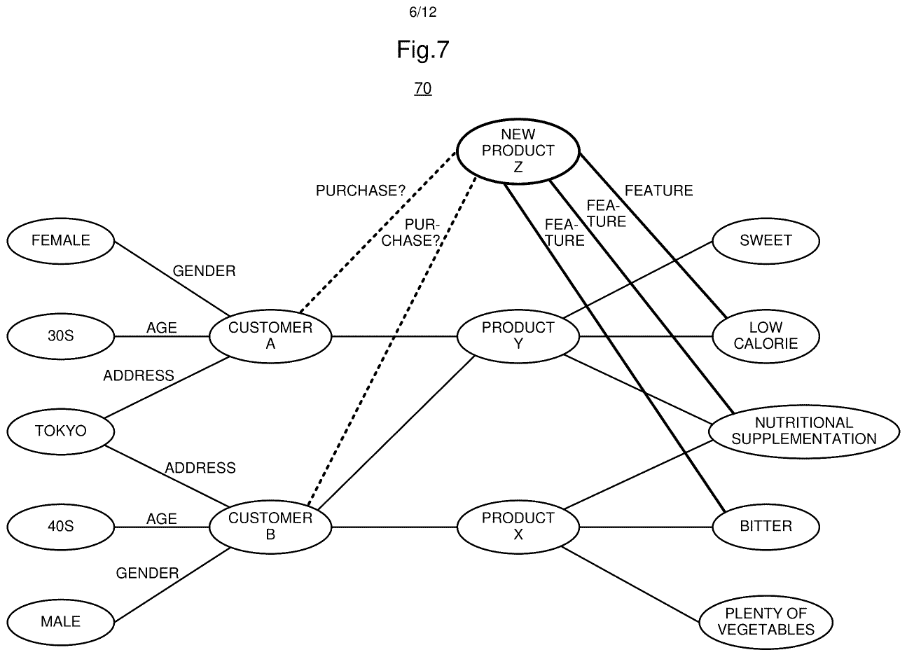

The prediction model training unit 115 acquires the graph data from the DB 15. The prediction model training unit 115 then learns relationships between the new product and customers by using the graph data, and generates a prediction model. For example, the prediction model training unit 115 trains the prediction model based on KBLRN by inputting feature quantities corresponding to each node included in the graph data and feature quantities corresponding to each relationship. FIG. 7 schematically illustrates the learned graph data. For graph data 70 of FIG. 7, the prediction model training unit 115 performs learning in such a way that a relationship between unlinked nodes is derived from the known relationship between the linked nodes in the graph data. In the graph data 70, the prediction model training unit 115 learns whether to provide links between the new product Z and customers. The prediction model training unit 115 outputs the generated prediction model to the prediction model output unit 116.

The KBLRN is a framework of graph-based relational learning, and a method described in the following document can be used.

Alberto Garcia-Duran and Mathias Niepert: KBLRN: End-to-End Learning of Knowledge Base Representations with Latent, Relational, and Numerical Features, the 34th Conference on Uncertainty in Artificial Intelligence (UAI) The prediction model output unit 116 outputs the prediction model input from the prediction model training unit 115 to a purchase score calculation unit 123 to be described later.

### (Prediction Model Generation Processing)

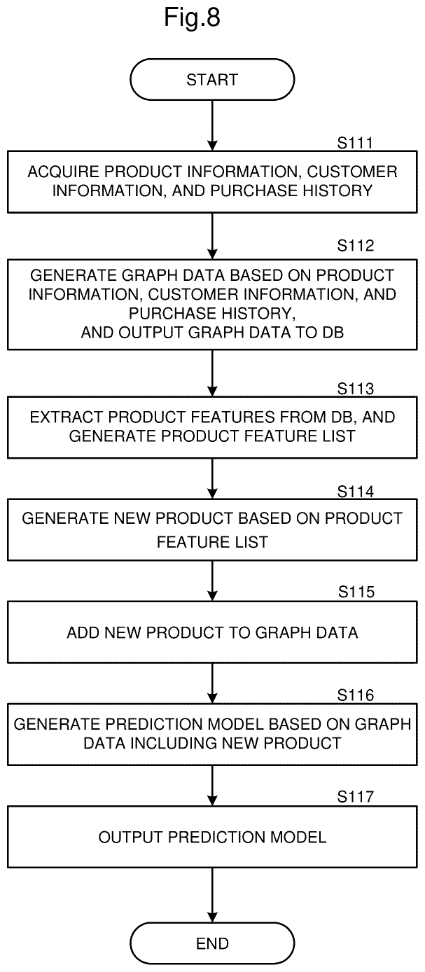

Next, the prediction model generation processing will be described. FIG. 8 is a flowchart of the prediction model generation processing by the training unit 110. This processing is achieved by the processor 12 illustrated in FIG. 2 executing a program prepared in advance and operating as each element illustrated in FIG. 3.

First, the prediction device 10 receives input of product information, customer information, and a purchase history through the IF 11. The graph conversion unit 111 generates graph data based on the product information, the customer information, and the purchase history, and outputs the graph data to the DB 15 (steps S111 and S112).

Next, the product feature extraction unit 112 acquires the graph data from the DB 15. The product feature extraction unit 112 then extracts product features from the graph data, and generates a product feature list. The product feature extraction unit 112 outputs the product feature list to the product feature combination unit 113 (step S113). Next, the product feature combination unit 113 generates a new product based on the product feature list input from the product feature extraction unit 112. Specifically, the product feature combination unit 113 selects one or a plurality of product features from the product feature list, and generates one or a plurality of new combinations of the product features. The product feature combination unit 113 outputs the new product to the new product data addition unit 114 (step S114). Next, the new product data addition unit 114 adds the new product input from the product feature combination unit 113 to the graph data of the DB 15 (step S115).

Next, the prediction model training unit 115 acquires the graph data from the DB 15. The prediction model training unit 115 then learns relationships between the new product and customers by using the graph data, and generates a prediction model. The prediction model training unit 115 outputs the generated prediction model to the prediction model output unit 116 (step S116).

Next, the prediction model output unit 116 outputs the prediction model input from the prediction model training unit 115 to the purchase score calculation unit 123 to be described later (step S117), and the prediction model generation processing ends.

### (Prediction Unit)

Next, the prediction unit 120 will be described. The prediction unit 120 includes a customer feature extraction unit 121, a customer feature combination unit 122, the purchase score calculation unit 123, and a purchase score output unit 124.

The customer feature extraction unit 121 acquires the graph data from the DB 15. The customer feature extraction unit 121 then extracts customer features from the graph data, and generates a customer feature list. The customer feature extraction unit 121 outputs the customer feature list to the customer feature combination unit 122.

The customer feature combination unit 122 selects one or a plurality of customer features from the customer feature list input from the customer feature extraction unit 121, and generates one or a plurality of combinations of the customer features.

Hereinafter, a customer having the generated combination of the customer features is also referred to as a “target customer”. The target customer is used as input data in a case where a purchase probability of the new product is predicted. The customer feature combination unit 122 outputs the target customer to the purchase score calculation unit 123.

The purchase score calculation unit 123 acquires the graph data from the DB 15. The purchase score calculation unit 123 receives input of the prediction model from the prediction model output unit 116, and receives input of the target customer from the customer feature combination unit 122. The purchase score calculation unit 123 predicts the purchase probability of each new product for each target customer using the prediction model. The purchase score calculation unit 123 then outputs a prediction result to the purchase score output unit 124.

The purchase score calculation unit 123 may predict the purchase probability for all the new products, that is, for all the new combinations of the product features included in the graph data, or may predict the purchase probability for only a predetermined new product. The predetermined new product can be specified by a user via the input unit 16 of the prediction device 10, for example. The purchase score calculation unit 123 may predict the purchase probability for all the target customers, that is, for all the combinations of the customer features included in the graph data, or may predict the purchase probability for a customer having a predetermined combination of the customer features. The predetermined combination of the customer features can be specified by the user via the input unit 16 of the prediction device 10, for example.

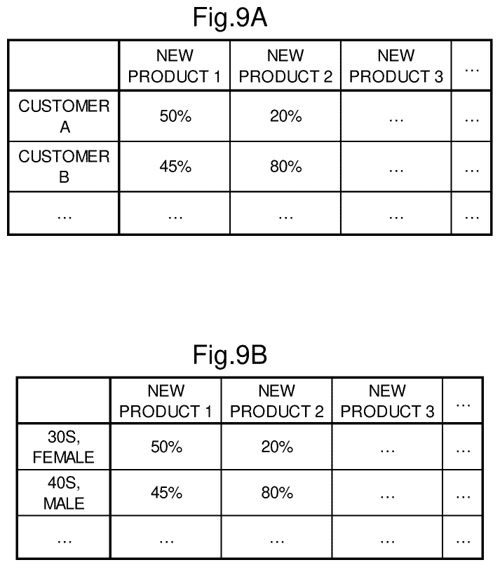

FIG. 9 illustrates an example of the prediction result. FIG. 9A illustrates the purchase probabilities of each new product for each target customer. For example, in FIG. 9A, the prediction device 10 predicts that a purchase probability of a new product 1 is 50% for the customer A. FIG. 9B illustrates the purchase probabilities of each new product for each set of the target customers. The set of the target customers is a set of the customers having the predetermined combination of the customer features. The prediction device 10 can output the prediction result by predicting the purchase probability of each customer included in the set of the target customers and calculating a representative value such as an average value or a mode. For example, in FIG. 9B, the prediction device 10 predicts that a purchase probability of the new product 1 is 50% for a set of customers having a combination of “30s” and “female” as the predetermined customer features.

The purchase score calculation unit 123 may output, to the purchase score output unit 124, an optimal combination of the target customer and the new product or an optimal new product as the prediction result. For example, the purchase score calculation unit 123 may output, to the purchase score output unit 124, a combination of the target customer and the new product having the highest purchase probability among the purchase probabilities of the new products for the sets of the target customers as an optimal combination. The purchase score calculation unit 123 may output, to the purchase score output unit 124, a new product having the highest purchase probability among the purchase probabilities of the new products for the sets of the target customers as an optimal new product. The purchase score calculation unit 123 may calculate, for each new product, an average value of the purchase probabilities of the target customers, and output, to the purchase score output unit 124, a new product having the highest average value of the purchase probabilities as an optimal new product.

### (Prediction Processing)

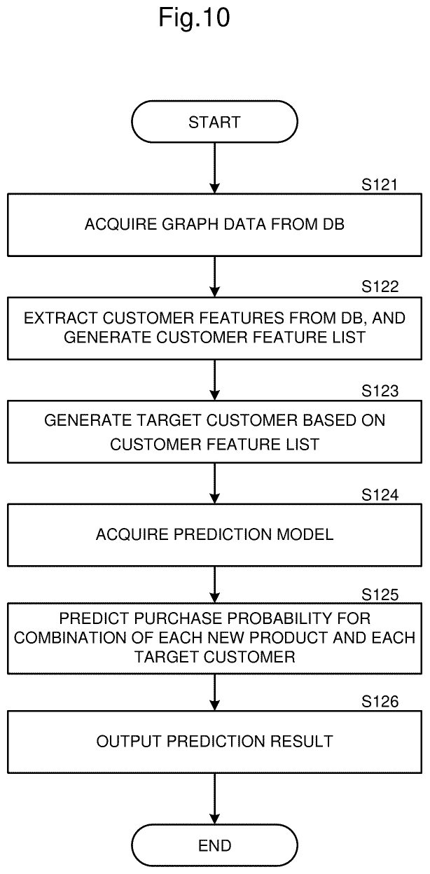

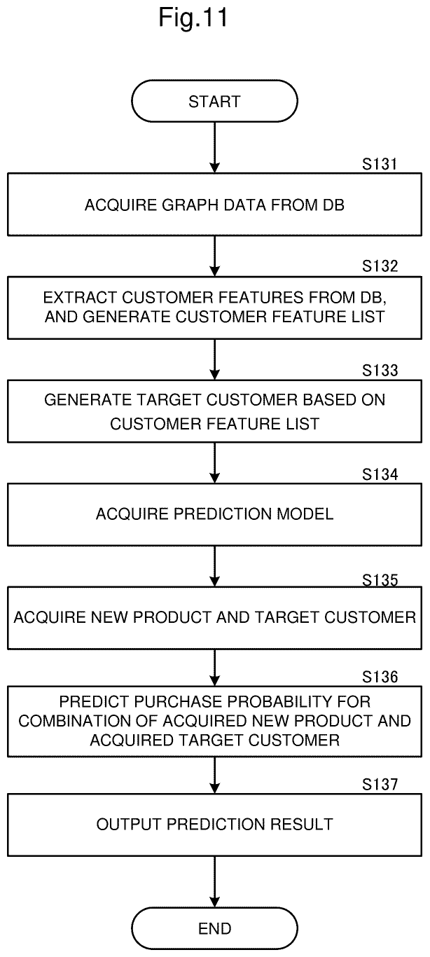

Next, the prediction processing will be described. FIGS. 10 and 11 are flowcharts of the prediction processing by the prediction unit 120. This processing is achieved by the processor 12 illustrated in FIG. 2 executing a program prepared in advance and operating as each element illustrated in FIG. 3.

In the prediction processing of FIG. 10, first, the customer feature extraction unit 121 acquires graph data from the DB 15 (step S121). The customer feature extraction unit 121 then extracts customer features from the graph data, and generates a customer feature list (step S122). Next, the customer feature combination unit 122 generates a target customer from the customer feature list input from the customer feature extraction unit 121. Specifically, the customer feature combination unit 122 selects one or a plurality of customer features from the customer feature list, and generates one or a plurality of target customers. The customer feature combination unit 122 outputs the target customer to the purchase score calculation unit 123 (step S123).

The purchase score calculation unit 123 receives input of a prediction model from the prediction model output unit 116 (step S124). The purchase score calculation unit 123 predicts the purchase probability of each new product for each target customer using the prediction model. The purchase score calculation unit 123 then outputs a prediction result to the purchase score output unit 124 (step S125).

The purchase score output unit 124 outputs the prediction result to the DB 15, the display unit 17, and the like (step S126), and the processing ends.

Next, the prediction processing of FIG. 11 will be described. FIG. 11 is different from the flowchart of the prediction processing of FIG. 10 in that a user specifies a new product and a customer to be predicted. The processing in steps S131 to S134 of FIG. 11 is similar to the processing in steps S121 to S124 of FIG. 10, and thus description thereof is omitted.

The user specifies a new product and a combination of customer features via the input unit 16 of the prediction device 10. The purchase score calculation unit 123 acquires the new product and the combination of customer features specified by the user (step S135). The purchase score calculation unit 123 predicts, using the prediction model, a purchase probability of the specified new product for each customer having the specified combination of customer features. The purchase score calculation unit 123 then outputs a prediction result to the purchase score output unit 124 (step S136). The purchase score output unit 124 outputs the prediction result to the DB 15, the display unit 17, and the like (step S137), and the processing ends.

In the above configuration, the graph conversion unit 111 is an example of graph data generation means, the product feature extraction unit 112 and the product feature combination unit 113 are an example of new product generation means, the new product data addition unit 114 is an example of new product addition means, the prediction model training unit 115 and the prediction model output unit 116 are an example of model generation means, the customer feature extraction unit 121 and the customer feature combination unit 122 are an example of customer feature generation means, and the purchase score calculation unit 123 is an example of acquisition means and prediction means. The purchase score output unit 124 is an example of the prediction means.

### MODIFICATIONS

Next, modifications of the first example embodiment will be described. The following modifications can be appropriately combined and applied to the first example embodiment.

### (Modification 1)

In the first example embodiment, the prediction device 10 predicts the purchase probability of the new product, but the prediction device 10 may predict a product feature to be added to the new product. For example, the prediction device 10 adds the product feature to the new product, and predicts the purchase probability of the new product to which the product feature is added. In a case where the purchase probability is equal to or more than a predetermined threshold, the prediction device 10 outputs the product feature added to the new product. As a result, a user can grasp which product feature is added to the new product to increase the purchase probability.

### (Modification 2)

The prediction device 10 can also be applied in a field of medicine. For example, the prediction device 10 can predict a probability that a new medicine will be effective for a patient. The prediction device 10 trains a prediction model based on input data such as medicine information, patient information, and a prescription history. At this time, the prediction device 10 uses a symptom as a feature of the patient, and uses efficacy, an effect, or the like as a feature of the medicine. The prediction device 10 then predicts a probability that the new medicine will be effective for the patient by using the prediction model.

### Second Example Embodiment

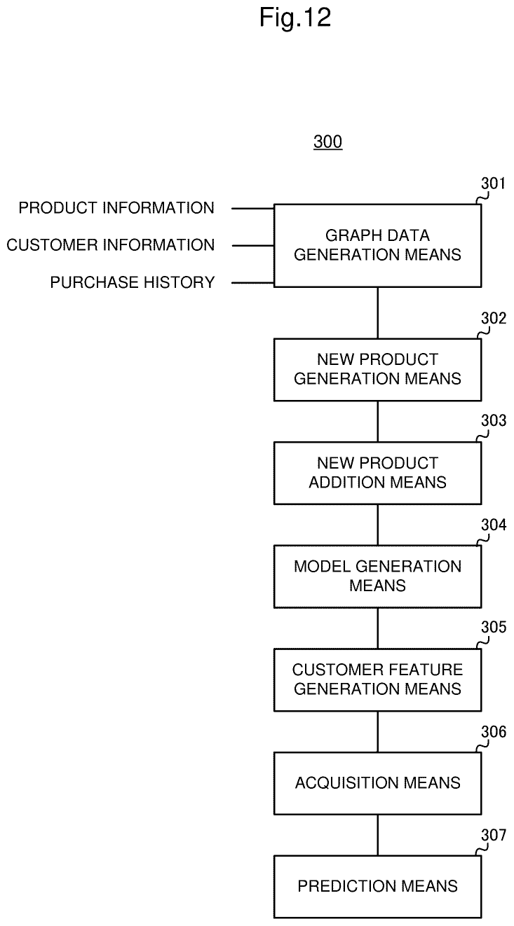

FIG. 12 is a block diagram illustrating a functional configuration of a prediction device of a second example embodiment. A prediction device 300 includes graph data generation means 301, new product generation means 302, new product addition means 303, model generation means 304, customer feature generation means 305, acquisition means 306, and prediction means 307.

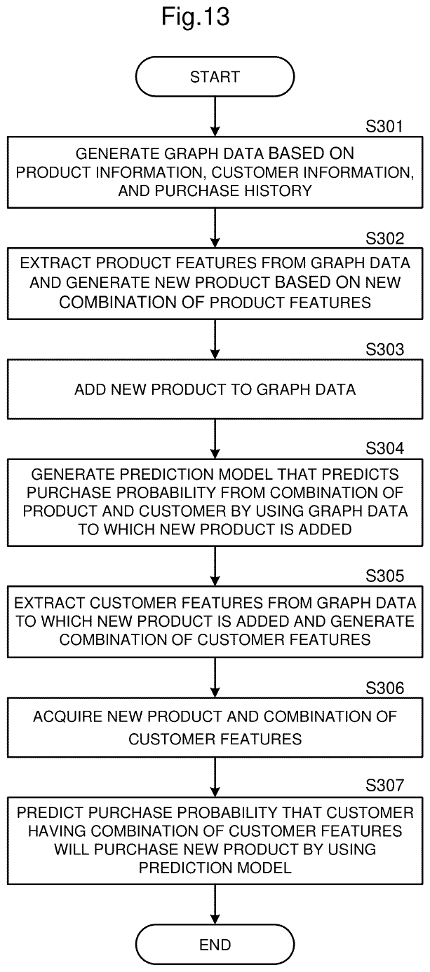

FIG. 13 is a flowchart of processing by the prediction device of the second example embodiment. The graph data generation means 301 generates graph data including a plurality of nodes and links indicating relationships between the nodes based on product information, customer information, and a purchase history (step S301). The new product generation means 302 extracts product features from the graph data, and generates a new product based on a new combination of the product features (step S302). The new product addition means 303 adds the new product to the graph data (step S303). The model generation means 304 generates a prediction model that predicts a purchase probability from a combination of a product and a customer by using the graph data to which the new product is added (step S304). The customer feature generation means 305 extracts customer features from the graph data to which the new product is added, and generates a combination of the customer features (step S305). The acquisition means 306 acquires the new product and the combination of the customer features (step S306). The prediction means 307 predicts a purchase probability that a customer having the combination of the customer features will purchase the new product by using the prediction model (step S307).

According to the prediction device 300 of the second example embodiment, it is possible to predict a new product having a high purchase probability using an existing purchase history or the like.

Some or all of the example embodiments described above may also be described as, but are not limited to, the following Supplementary Notes.

### (Supplementary Note 1)

A prediction device comprising:
graph data generation means for generating graph data including a plurality of nodes and links indicating relationships between the nodes based on product information, customer information, and a purchase history;
new product generation means for extracting product features from the graph data and generating a new product based on a new combination of the product features;
new product addition means for adding the new product to the graph data; model generation means for generating a prediction model that predicts a purchase probability from a combination of a product and a customer by using the graph data to which the new product is added;
customer feature generation means for extracting customer features from the graph data to which the new product is added and generating a combination of the customer features;
acquisition means for acquiring the new product and the combination of the customer features; and
prediction means for predicting a purchase probability that a customer having the combination of the customer features will purchase the new product by using the prediction model.

### (Supplementary Note 2)

The prediction device according to supplementary note 1, wherein the prediction means outputs an optimal combination of a customer and a new product or an optimal new product based on a result of the prediction.

### (Supplementary Note 3)

The prediction device according to supplementary note 2, wherein the prediction means outputs, as an optimal combination, a combination having a highest purchase probability among combinations of customers having the combination of the customer features and the new product.

### (Supplementary Note 4)

The prediction device according to supplementary note 1, wherein the graph data generation means generates the graph data by combining a customer and a customer feature with a customer feature link, combining a product and a product feature with a product feature link, and combining the product and the customer with a purchase link, based on the product information, the customer information, and the purchase history.

### (Supplementary Note 5)

The prediction device according to supplementary note 1 or 2, wherein
the acquisition means acquires a predetermined new product from all new products generated by the new product generation means, and the prediction means predicts a purchase probability for the predetermined new product.

### (Supplementary Note 6)

The prediction device according to supplementary note 1 or 2, wherein
the acquisition means acquires a predetermined combination of customer features from all combinations of customer features generated by the customer feature generation means, and
the prediction means predicts a purchase probability for a customer having the predetermined combination of the customer features.

### (Supplementary Note 7)

The prediction device according to supplementary note 1, further comprising
product feature addition means for adding a product feature to the new product,
wherein the prediction means predicts a purchase probability for the new product to which the product feature is added, and outputs the added product feature in a case where the purchase probability is equal to or more than a predetermined threshold.

### (Supplementary Note 8)

A prediction method comprising:
generating graph data including a plurality of nodes and links indicating relationships between the nodes based on product information, customer information, and a purchase history;
extracting product features from the graph data and generating a new product based on a new combination of the product features;
adding the new product to the graph data; generating a prediction model that predicts a purchase probability from a combination of a product and a customer by using the graph data to which the new product is added;
extracting customer features from the graph data to which the new product is added and generating a combination of the customer features;
acquiring the new product and the combination of the customer features; and
predicting a purchase probability that a customer having the combination of the customer features will purchase the new product by using the prediction model.

### (Supplementary Note 9)

A recording medium recording a program for causing a computer to execute processing comprising:
generating graph data including a plurality of nodes and links indicating relationships between the nodes based on product information, customer information, and a purchase history;
extracting product features from the graph data and generating a new product based on a new combination of the product features;
adding the new product to the graph data;
generating a prediction model that predicts a purchase probability from a combination of a product and a customer by using the graph data to which the new product is added;
extracting customer features from the graph data to which the new product is added and generating a combination of the customer features;
acquiring the new product and the combination of the customer features; and
predicting a purchase probability that a customer having the combination of the customer features will purchase the new product by using the prediction model.

While the present disclosure has been particularly shown and described with reference to example embodiments and examples thereof, the present disclosure is not limited to these example embodiments and examples. It will be understood by those of ordinary skill in the art that various changes in form and details may be made therein without departing from the spirit and scope of the present disclosure as defined by the claims.

### DESCRIPTION OF SYMBOLS

10 prediction device
110 training unit
111 graph conversion unit
112 product feature extraction unit
113 product feature combination unit
114 new product data addition unit
115 prediction model training unit
116 prediction model output unit
120 prediction unit
121 customer feature extraction unit
122 customer feature combination unit
123 purchase score calculation unit
124 purchase score output unit

What is claimed is:

1. A prediction device comprising:
at least one memory configured to store instructions; and
at least one processor configured to execute the instructions to:
generate graph data including a plurality of nodes and links indicating relationships between the nodes based on product information, customer information, and a purchase history;
extract product features from the graph data and generate a new product based on a new combination of the product features;
add the new product to the graph data;
generate a prediction model that predicts a purchase probability from a combination of a product and a customer by machine learning with using the graph data to which the new product is added;
extract customer features from the graph data to which the new product is added and generate a combination of the customer features;
acquire the new product and the combination of the customer features; and
predict a purchase probability that a customer having the combination of the customer features will purchase the new product by using the prediction model.

2. The prediction device according to claim 1, wherein the one or more processors output an optimal combination of a customer and a new product or an optimal new product based on a result of the prediction.

3. The prediction device according to claim 2, wherein the one or more processors output, as an optimal combination, a combination having a highest purchase probability among combinations of customers having the combination of the customer features and the new product.

4. The prediction device according to claim 1, wherein the one or more processors generate the graph data by combining a customer and a customer feature with a customer feature link, combining a product and a product feature with a product feature link, and combining the product and the customer with a purchase link, based on the product information, the customer information, and the purchase history.

5. The prediction device according to claim 1, wherein
the one or more processors acquire a predetermined new product from all the generated new products, and
the one or more processors predict a purchase probability for the predetermined new product.

6. The prediction device according to claim 1, wherein
the one or more processors acquire a predetermined combination of customer features from all the generated combinations of customer features, and
the one or more processors predict a purchase probability for a customer having the predetermined combination of the customer features.

7. The prediction device according to claim 1, the one or more processors are further configured to:
add a product feature to the new product,
wherein the one or more processors predict a purchase probability for the new product to which the product feature is added, and output the added product feature in a case where the purchase probability is equal to or more than a predetermined threshold.

8. A prediction method comprising:
generating graph data including a plurality of nodes and links indicating relationships between the nodes based on product information, customer information, and a purchase history;
extracting product features from the graph data and generating a new product based on a new combination of the product features;
adding the new product to the graph data;
generating a prediction model that predicts a purchase probability from a combination of a product and a customer by machine learning with using the graph data to which the new product is added;
extracting customer features from the graph data to which the new product is added and generating a combination of the customer features;
acquiring the new product and the combination of the customer features; and
predicting a purchase probability that a customer having the combination of the customer features will purchase the new product by using the prediction model.

9. A non-transitory computer readable recording medium recording a program for causing a computer to execute processing comprising:
generating graph data including a plurality of nodes and links indicating relationships between the nodes based on product information, customer information, and a purchase history;
extracting product features from the graph data and generating a new product based on a new combination of the product features;
adding the new product to the graph data;
generating a prediction model that predicts a purchase probability from a combination of a product and a customer by machine learning with using the graph data to which the new product is added;
extracting customer features from the graph data to which the new product is added and generating a combination of the customer features;
acquiring the new product and the combination of the customer features; and
predicting a purchase probability that a customer having the combination of the customer features will purchase the new product by using the prediction model.
